(19) United States
(12) Patent Application Publication
(10) Pub. No.: US 2013/0128405 A1
(43) Pub. Date: May 23, 2013

(54) AUTOMATIC THERMAL SHUTDOWN CIRCUIT

(71) Applicant: Kyoung Ho LEE, Hwaseong (KR)

(72) Inventor: Kyoung Ho LEE, Hwaseong (KR)

(73) Assignee: SAMSUNG ELECTRO-MECHANICS CO., LTD.

(21) Appl. No.: 13/362,859

(22) Filed: Jan. 31, 2012

(30) Foreign Application Priority Data
Nov. 21, 2011 (KR) 10-2011-0121831

(51) Int. Cl. H02H 3/20; H02H 5/04

(52) U.S. Cl. 361/91.1; 361/103

(57) ABSTRACT

An automatic thermal shutdown circuit includes: a first temperature detection unit detecting a temperature equal to or above a pre-set first temperature to provide a first temperature detection signal; a second temperature detection unit detecting a pre-set second temperature, lower than the first temperature, and providing a second temperature detection signal; and a shutdown signal generation unit providing a shut down signal according to the first temperature detection signal from the first temperature detection unit and cutting the shutdown signal according to the second temperature detection signal from the second temperature detection unit.

### CROSS-REFERENCE TO RELATED APPLICATIONS

This application claims the priority of Korean Patent Application No. 10-2011-0121831 filed on Nov. 21, 2011, in the Korean Intellectual Property Office, the disclosure of which is incorporated herein by reference.

### BACKGROUND OF THE INVENTION

1. Field of the Invention

The present invention relates to an automatic thermal shutdown circuit, applicable to a motor driver IC, which can be implemented through a CMOS process, and can automatically perform a shutdown function within a pre-set temperature range.

2. Description of the Related Art

In general, a driving device such as a motor driver integrated circuit (IC), or the like, may be damaged when the temperature thereof rises significantly. Thus, the driving device requires a thermal shutdown function to protect itself when the temperature thereof rises.

Referring to the thermal shutdown function of the motor driver IC, in general, when a temperature rises above a reference temperature, thermal shutdown is initiated, and when the temperature falls to a normal temperature level, thermal shutdown may be automatically ended.

However, the related art thermal shutdown circuit initiates thermal shutdown when the temperature rises to higher than a reference temperature, but is not automatically thermally shut down.

Also, the related art thermal shutdown circuit is implemented with a BJT transistor, taking up a large area, and since an additional BJT fabrication process should be necessarily performed, the fabrication process is complicated and the cost increases.

### SUMMARY OF THE INVENTION

An aspect of the present invention provides an automatic thermal shutdown circuit applicable to a motor driver IC, implementable through a CMOS process, and able to automatically perform a shutdown function within a pre-set temperature range.

According to an aspect of the present invention, there is provided an automatic thermal shutdown circuit including: a first temperature detection unit detecting a temperature equal to or above a pre-set first temperature and providing a first temperature detection signal; a second temperature detection unit detecting a temperature equal to or below a second temperature previously set to be lower than the first temperature and providing a second temperature detection signal; and a shutdown signal generation unit providing a shut down signal according to the first temperature detection signal from the first temperature detection unit and cutting the shutdown signal according to the second temperature detection signal from the second temperature detection unit.

The first and second temperature detection units and the shutdown signal generation unit may be implemented through a CMOS process using a MOSFET.

The first temperature detection unit may include: a first PTAT current generation unit generating a first current proportional to an absolute temperature; a first current/voltage conversion unit converting the first current into a first temperature-proportional voltage; and a first comparison unit providing the first temperature detection signal when the first temperature-proportional voltage is higher than a pre-set first reference voltage so as to correspond to the first temperature.

The second temperature detection unit may include a second PTAT current generation unit set to have the same temperature characteristics as those of the first PTAT current generation unit and generating a second current proportional to the absolute temperature and equal to the first current; a second current/voltage conversion unit converting the second current into a second temperature-proportional voltage equal to the first temperature-proportional voltage; and a second comparison unit providing a second temperature detection signal when the second temperature-proportional voltage is lower than or equal to a second reference voltage previously set to be lower than the first reference voltage so as to correspond to a second temperature lower than the first temperature.

The first temperature detection unit may include: a first PTAT current generation unit generating a first current proportional to an absolute temperature; a first current/voltage conversion unit converting the first current into a first temperature-proportional voltage; and a first comparison unit providing the first temperature detection signal when the first temperature-proportional voltage is higher than a first reference voltage previously set to correspond to the first temperature.

The second temperature detection unit may include a second PTAT current generation unit set to have temperature characteristics different from those of the first PTAT current generation unit and generating a second current proportional to the absolute temperature; a second current/voltage conversion unit converting the second current into a second temperature-proportional voltage; and a second comparison unit providing a second temperature detection signal when the second temperature-proportional voltage is lower than or equal to the first reference voltage.

The shutdown signal generation unit may include an RS latch, set to provide the shutdown signal when the first temperature detection signal has a high level, and reset to cut the shutdown signal when the second temperature detection signal has a high level.

According to another aspect of the present invention, there is provided an automatic thermal shutdown method including: detecting a first temperature-proportional voltage through a first PTAT current generation unit; comparing the first temperature-proportional voltage with a first reference voltage previously set to correspond to a pre-set first temperature to determine whether or not the first temperature-proportional voltage is higher than the first reference voltage; performing a shutdown, via a shutdown signal generation unit, when the first temperature-proportional voltage is higher than the first reference voltage, and detecting a second temperature-proportional voltage through a second PTAT current generation unit; comparing the second temperature-proportional voltage with a second reference voltage previously set to correspond to a pre-set second temperature to determine whether the second temperature-proportional voltage is lower than or equal to the second reference voltage; and ending the shutdown by the shutdown signal generation unit when the second temperature-proportional voltage is lower than or equal to the second reference voltage.

The first temperature detection unit, the second temperature detection unit and the shutdown signal generation unit may be implemented through a CMOS process using a MOSFET, respectively.

In the performing of the shutdown, when the first temperature-proportional voltage is higher than the first reference voltage, a first temperature detection signal may be provided to perform the shutdown.

In the ending of the shutdown, when the second temperature-proportional voltage is lower than or equal to the second reference voltage, a second temperature detection signal may be provided to perform the shutdown.

The detecting of the first temperature-proportional voltage may include: generating, by a first PTAT current generation unit, a first current proportional to the absolute temperature; and converting the first current into a first temperature-proportional voltage.

The performing of the shutdown may include: generating, by a second PTAT current generation unit set to have the same temperature characteristics as those of the first PTAT current generation unit, a second current proportional to the absolute temperature and equal to the first current; and converting the second current into a second temperature-proportional voltage equal to the first temperature-proportional voltage.

In the comparing of the second temperature-proportional voltage with the second reference voltage to determine whether the second temperature-proportional voltage is lower than or equal to the second reference voltage, the second temperature may be set to be lower than the first temperature, so the second reference voltage and the first reference voltage may be set to be different voltages.

The performing of the shutdown may include: generating, by the second PTAT current generation unit set to have temperature characteristics different from those of the first PTAT current generation unit, a second current proportional to the absolute temperature; and converting the second current into the second temperature-proportional voltage.

In the comparing of the second temperature-proportional voltage with the second reference voltage to determine whether the second temperature-proportional voltage is lower than or equal to the second reference voltage, the second reference voltage and the first reference voltage may be set to be equal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of an automatic thermal shutdown circuit according to an embodiment of the present invention.

FIG. 2 is a shutdown conceptual view of the automatic thermal shutdown circuit according to an embodiment of the present invention.

FIG. 3 is a first implementation view of first and second temperature detection units according to an embodiment of the present invention.

FIG. 4 is a second implementation view of first and second temperature detection units according to an embodiment of the present invention.

FIG. 5 is a view explaining operations of the first and second temperature detection units of FIG. 3.

FIG. 6 is a view explaining operations of the first and second temperature detection units of FIG. 4.

FIG. 7 is a view explaining a shutdown operation of the automatic thermal shutdown circuit according to an embodiment of the present invention.

FIG. 8 is a view explaining a shutdown operation of the automatic thermal shutdown circuit according to another embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

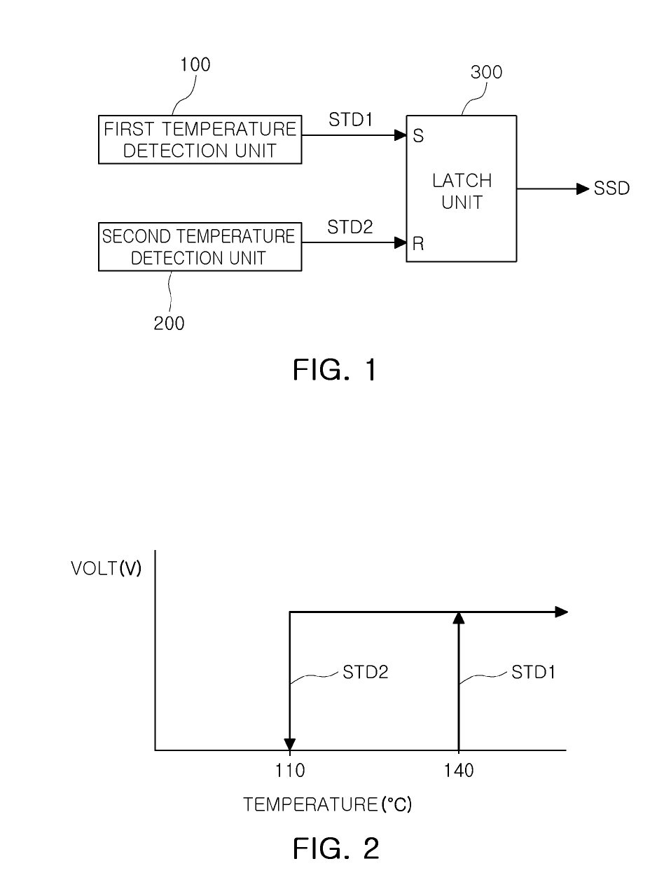

FIG. 1 is a schematic block diagram of an automatic thermal shutdown circuit according to an embodiment of the present invention. FIG. 2 is a shutdown conceptual view of the automatic thermal shutdown circuit according to an embodiment of the present invention.

With reference to FIG. 1, an automatic thermal shutdown circuit according to an embodiment of the present invention may include a first temperature detection unit 100 detecting a temperature equal to or above a pre-set first temperature T1 and providing a first temperature detection signal STD1, a second temperature detection unit 200 detecting a temperature equal to or below a second temperature T2 previously set to be lower than the first temperature and providing a second temperature detection signal STD2, and a shutdown signal generation unit 300 providing a shut down signal according to the first temperature detection signal STD1 and cutting the shutdown signal according to the second temperature detection signal STD2.

Here, the first and second temperature detection units 100 and 200 and the shutdown signal generation unit 300 may be implemented through a CMOS process using a MOSFET, respectively. Accordingly, the size of these elements and the unit production cost thereof can be reduced in comparison to a case in which they are implemented by a BJT transistor.

The automatic thermal shutdown circuit according to an embodiment of the present invention will be described with reference to FIG. 1.

In FIG. 1, the first temperature detection unit 100 may detect the pre-set first temperature T1 and provide the first temperature detection signal STD1. Here, as shown in FIG. 2, the first temperature T1 is a reference temperature used for determining a high temperature at which a system, to which it is applied, may be damaged. The first temperature T1 may be appropriately set according to the environment of an applied system and may be, for example, 140° C.

The second temperature detection unit 200 may detect a pre-set second temperature T2, previously set to be lower than the first temperature T1, and provide a second temperature detection signal STD2. Here, as shown in FIG. 2, the second temperature T2 is a reference temperature used for determining that an applied system is outside of a high temperature at which it may be damaged. The second temperature T2 may be appropriately set according to the environment of an applied system and may be, for example 110° C.

The shutdown signal generation unit 300 may provide a shutdown signal according to the first temperature detection signal STD1 from the first temperature detection unit 100 and cut the shutdown signal according to the second temperature detection signal STD2 from the second temperature detection unit 200.

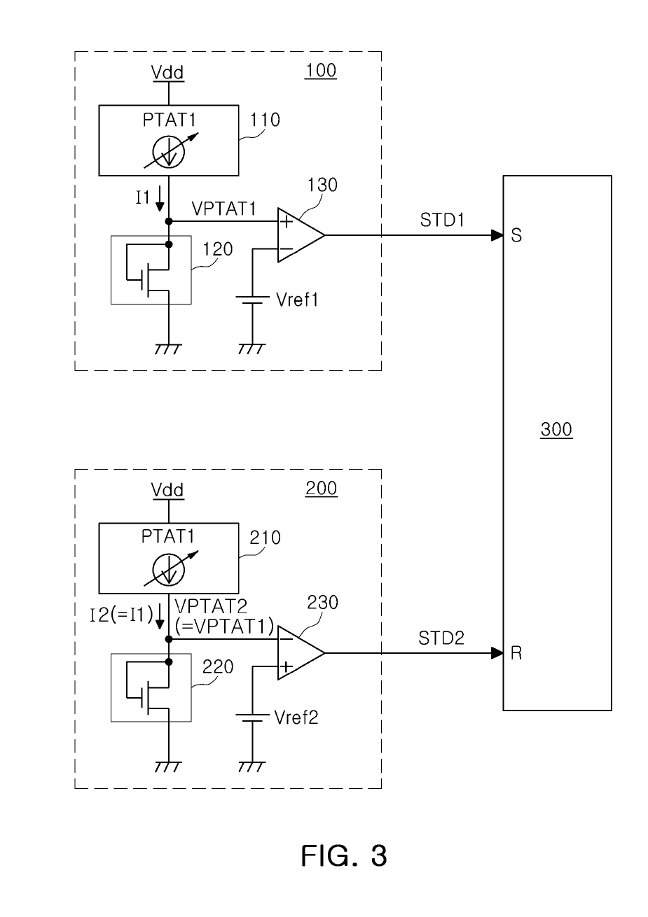

FIG. 3 is a first implementation view of the first and second temperature detection units according to an embodiment of the present invention.

With reference to FIG. 3, the first temperature detection unit 100 may include a first PTAT current generation unit 110 generating a first current I1 proportional to the absolute temperature, a first current/voltage conversion unit 120 converting the first current I1 into a first temperature-proportional voltage VPTAT1, and a first comparison unit 130 providing the first temperature detection signal STD1 when the first temperature-proportional voltage VPTAT1 is higher than a first reference voltage Vref1, previously set to correspond to the first temperature T1.

The second temperature detection unit 200 may include a second PTAT current generation unit 210 set to have the same temperature characteristics as those of the first PTAT current generation unit 110 and generating a second current I2 proportional to the absolute temperature and equal to the first current I1, a second current/voltage conversion unit 220 converting the second current I2 into a second temperature-proportional voltage VPTAT2 equal to the first temperature-proportional voltage, and a second comparison unit 230 providing the second temperature detection signal STD2 when the second temperature-proportional voltage VPTAT2 is equal to or lower than a second reference voltage Vref2, previously set to correspond to the second temperature T2, lower than the first temperature T1.

The shutdown signal generation unit 300 may include an RS latch. When the first temperature detection signal STD1 has a high level, the RS latch is set to provide the shutdown signal, and when the second temperature detection signal STD2 has a high level, the RS latch is reset to cut the shutdown signal.

The first temperature detection unit 100 will be described with reference to FIG. 3.

In FIG. 3, the first PTAT current generation unit 110 of the first temperature detection unit 100 may generate the first current I1 proportional to the absolute temperature and provide the same to the first current/voltage conversion unit 120.

The first current/voltage conversion unit 120 may convert the first current I1 into the first temperature-proportional voltage VPTAT1 and provide the same to the first comparison unit 130. Here, the first current/voltage conversion unit 120 may include a first resistor, and the first current generated by the first PTAT current generation unit 110 may be converted into a voltage by the first resistor.

When the first temperature-proportional voltage VPTAT1 is higher than the first reference voltage Vref1, previously set to correspond to the first temperature T1, the first comparison unit 130 may provide the first temperature detection signal STD1 having a high level. Meanwhile, when the first temperature-proportional voltage VPTAT1 is lower than or equal to the first reference voltage Vref1, the first comparison unit 130 may provide a low level signal.

The second temperature detection unit 200 will be described with reference to FIG. 3.

In FIG. 3, the second PTAT current generation unit 210 of the second temperature detection unit 200 may be set to have the same temperature characteristics as those of the first PTAT current generation unit 110 and generate a second current I2 proportional to the absolute temperature and equal to the first current.

Also, the second current/voltage conversion unit 220 may convert the second current I2 into the second temperature-proportional voltage VPTAT2, equal to the first temperature-proportional voltage. Here, the second current/voltage conversion unit 220 may include a second resistor having the same resistance value as that of the first resistor, and the second current generated by the second PTAT current generation unit 210 may be converted into a voltage by the second resistor.

When the second temperature-proportional voltage VPTAT2 is lower than the second reference voltage Vref2, previously set to be lower than the first reference voltage Vref1 so as to correspond to the second temperature T2 lower than the first temperature T1, the second comparison unit 230 may provide the second temperature detection signal STD2. Meanwhile, when the second temperature-proportional voltage VPTAT2 is higher than the second reference voltage Vref2, the second comparison unit 230 may provide a low level signal.

When the first temperature detection signal STD1 has a high level, the RS latch of the shutdown signal generation unit 300 may be set to provide the shutdown signal, and while the shutdown signal is being provided, when the second temperature detection signal STD2 has a high level, the RS latch of the shutdown signal generation unit 300 may be reset to cut the shutdown signal.

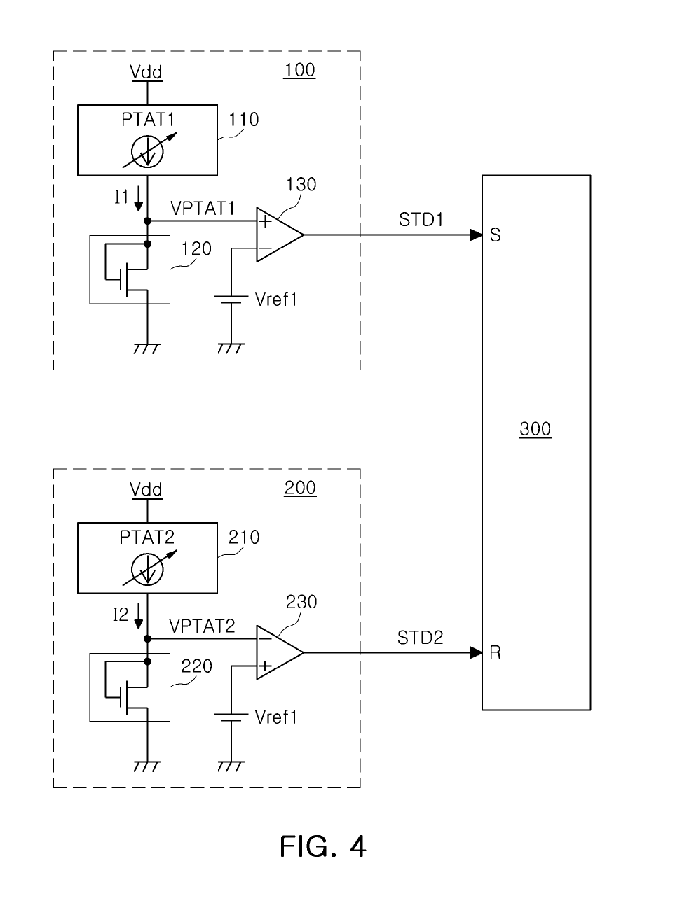

FIG. 4 is a second implementation view of the first and second temperature detection units according to an embodiment of the present invention.

With reference to FIG. 4, the first temperature detection unit 100 may include the first PTAT current generation unit 110 generating the first current I1 proportional to the absolute temperature, the first current/voltage conversion unit 120 converting the first current I1 into the first temperature-proportional voltage VPTAT1, and the first comparison unit 130 providing the first temperature detection signal STD1 when the first temperature-proportional voltage VPTAT1 is higher than the first reference voltage Vref1 previously set to correspond to the first temperature T1.

The second temperature detection unit 200 may include the second PTAT current generation unit 210 set to have temperature characteristics different from those of the first PTAT current generation unit 110 and generating the second current I2 proportional to the absolute temperature and equal to the first current I1, the second current/voltage conversion unit 220 converting the second current I2 into the second temperature-proportional voltage VPTAT2, and the second comparison unit 230 providing the second temperature detection signal STD2 when the second temperature-proportional voltage VPTAT2 is lower than or equal to the first reference voltage Vref1.

The shutdown signal generation unit 300 may include the RS latch. When the first temperature detection signal STD1 has a high level, the RS latch is set to provide the shutdown signal, and when the second temperature detection signal STD2 has a high level, the RS latch is reset to cut the shutdown signal.

The first temperature detection unit 100 will be described with reference to FIG. 4.

In FIG. 4, the first PTAT current generation unit 110 of the first temperature detection unit 100 may generate the first current I1 proportional to the absolute temperature.

The first current/voltage conversion unit 120 may convert the first current I1 into the first temperature-proportional voltage VPTAT1. Here, the first current/voltage conversion unit 120 may include a first resistor, and the first current generated by the first PTAT current generation unit 110 may be converted into a voltage by the first resistor.

When the first temperature-proportional voltage VPTAT1 is higher than the first reference voltage Vref1 previously set to correspond to the first temperature T1, the first comparison unit 130 may provide the first temperature detection signal STD1. Meanwhile, when the first temperature-proportional voltage VPTAT1 is lower than or equal to the first reference voltage Vref1, the first comparison unit 130 may provide a low level signal.

The second temperature detection unit 200 will be described with reference to FIG. 4.

In FIG. 4, the second PTAT current generation unit 210 of the second temperature detection unit 200 may be set to have temperature characteristics different from those of the first PTAT current generation unit 110 and generate the second current I2 proportional to the absolute temperature. Here, the second current/voltage conversion unit 220 may include a second resistor having the same resistance value as that of the first resistor, and the second current I2 generated by the second PTAT current generation unit 210 may be converted into a voltage by the second resistor.

The second current/voltage conversion unit 220 may convert the second current I2 into the second temperature-proportional voltage VPTAT2.

When the second temperature-proportional voltage VPTAT2 is lower than or equal to the first reference voltage Vref1, the second comparison unit 230 may provide the second temperature detection signal STD2. Meanwhile, when the second temperature-proportional voltage VPTAT2 is higher than the first reference voltage Vref1, the second comparison unit 230 may provide a low level signal.

When the first temperature detection signal STD1 has a high level, the RS latch of the shutdown signal generation unit 300 may be set to provide the shutdown signal, and while the shutdown signal is being provided, when the second temperature detection signal STD2 has a high level, the RS latch of the shutdown signal generation unit 300 may be reset to cut the shutdown signal.

Meanwhile, the first and second PTAT current generation units 100 and 200 may be implemented by using a known circuit implemented by using a MOSFET according to the known art, such as those disclosed in Korean Laid Open Publication No. 10-2010-0061900, Korean Laid Open Publication No. 10-2003-0009582, and the like.

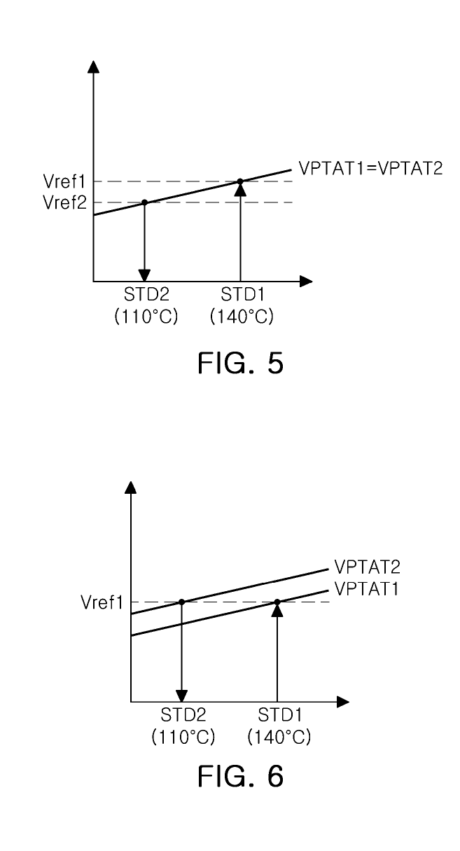

FIG. 5 is a view explaining operations of the first and second temperature detection units of FIG. 3. FIG. 6 is a view explaining operations of the first and second temperature detection units of FIG. 4.

With reference to the graph illustrated in FIG. 5, the first and second temperature detection units 100 and 200 in FIG. 3 have the same temperature characteristics and mutually different first and second reference voltages Vref1 and Vref2. In the first and second temperature detection units 100 and 200, when the temperature is 140° C. or above, the first temperature detection signal STD1 having a high level is output, and when the temperature is 110° C. or below, the second temperature detection signal STD2 having a high level is output.

Also, with reference to the graph illustrated in FIG. 6, the first and second temperature detection units 100 and 200 in FIG. 4 have the mutually different temperature characteristics and the same first reference voltage Vref1. In the first and second temperature detection units 100 and 200, when the temperature is 140° C. or above, the first temperature detection signal STD1 having a high level is output, and when the temperature is 110° C. or below, the second temperature detection signal STD2 having a high level is output.

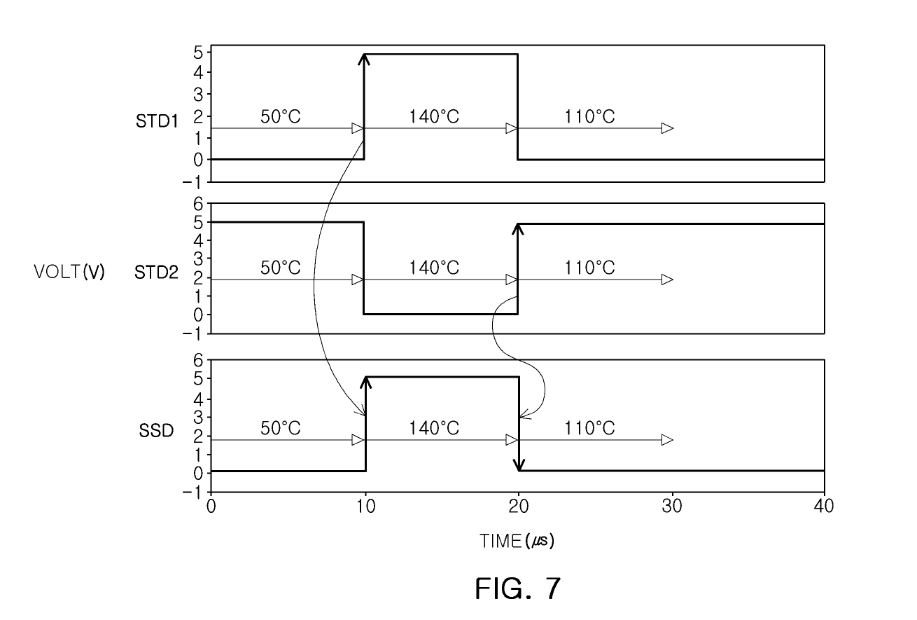

FIG. 7 is a view explaining a shutdown operation of the automatic thermal shutdown circuit according to an embodiment of the present invention.

With reference to FIG. 7, for example, when the temperature, maintained at 50° C., is increased to 140° C., the first temperature detection signal STD1 having a high level may be output, when then the temperature, maintained at 140° C., is dropped to 110° C., the second temperature detection signal STD2 having a low level may be output, resulting in that the shutdown signal SSD may be output.

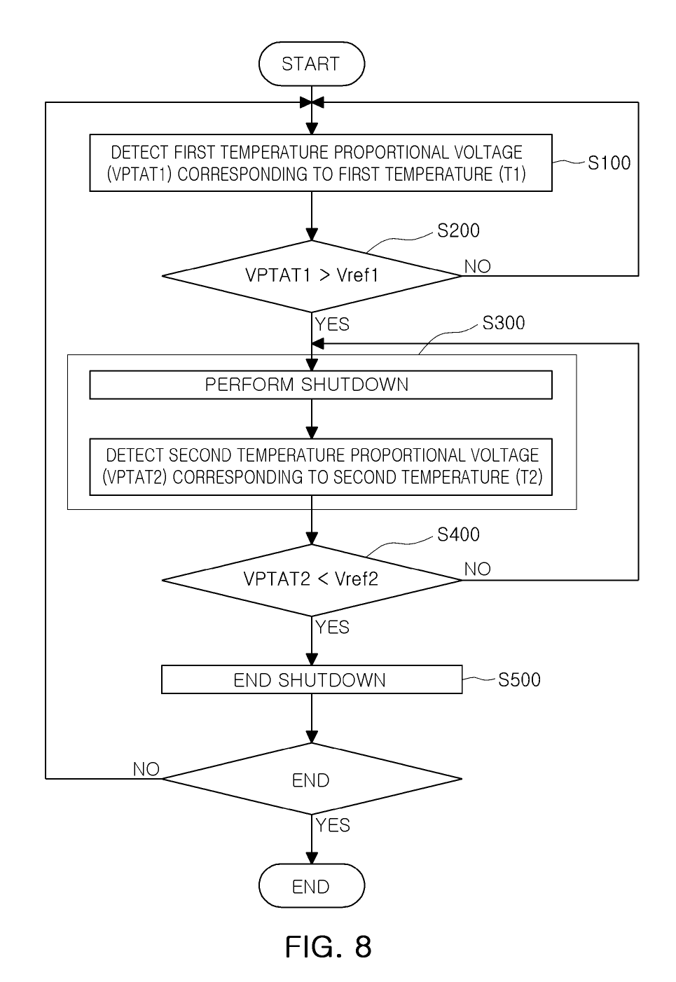

FIG. 8 is a view explaining a shutdown operation of the automatic thermal shutdown circuit according to another embodiment of the present invention.

With reference to FIG. 8, the automatic thermal shutdown method according to another embodiment of the present invention may include step S100 of detecting the first temperature-proportional voltage VPTAT1 through the first PTAT current generation unit 110, step S200 of comparing the first temperature-proportional voltage VPTAT1 with the first reference voltage Vref1 previously set to correspond to the pre-set first temperature T1 to determine whether the first temperature-proportional voltage VPTAT1 is higher than the first reference voltage Vref1, step S300 of performing shutdown by the shutdown signal generation unit 300 when the first temperature-proportional voltage VPTAT1 is higher than the first reference voltage Vref1, and detecting the second temperature-proportional voltage VPTAT1 through the second PTAT current generation unit 210, step S400 of comparing the second temperature-proportional voltage VPTAT2 with the second reference voltage Vref2, previously set to correspond to the pre-set second temperature T2 to determine whether or not the second temperature-proportional voltage VPTAT2 is lower than or equal to the second reference voltage Vref2, and step S500 of ending the shutdown being performed by the shutdown signal generation unit 300 when the second temperature-proportional voltage VPTAT2 is lower than the second reference voltage Vref2.

Here, the first and second temperature detection units 100 and 200 and the shutdown signal generation unit 300 may be implemented through a CMOS process using a MOSFET, respectively. Accordingly, the size of these elements and the unit production cost can be reduced in comparison to a case in which they are implemented by a BJT transistor.

The automatic thermal shutdown method according to another embodiment of the present invention will be described with reference to FIGS. 1 through 8.

With reference to FIGS. 1 through 8, in step S100, the first temperature-proportional voltage VPTAT1 may be detected by the first PTAT current generation unit 110.

In step S200, the first temperature-proportional voltage VPTAT1 is compared with the first reference voltage Vref1 previously set to correspond to the pre-set first temperature T1 to determine whether or not the first temperature-proportional voltage VPTAT1 is higher than the first reference voltage Vref1.

In step S300, when the first temperature-proportional voltage VPTAT1 is higher than the first reference voltage Vref1, the shutdown signal generation unit 300 may generate a shutdown signal for performing a shutdown, and the second temperature-proportional voltage VPTAT2 may be detected through the second PTAT current generation unit 210.

In step S400, the second temperature-proportional voltage VPTAT2 is compared with the second reference voltage Vref2 previously set to correspond to the pre-set second temperature T2 to determine whether or not the second temperature-proportional voltage VPTAT2 is lower than or equal to the second reference voltage Vref2.

In step S500, when the second temperature-proportional voltage VPTAT2 is lower than or equal to the second reference voltage Vref2, the shutdown signal generation unit 300 may stop generation of the shutdown signal in order to end shutdown being performed.

In step S300 of performing the shutdown, when the first temperature-proportional voltage VPTAT1 is higher than the first reference voltage Vref1, the first temperature detection signal STD1 may be provided to perform the shutdown.

In step S600 of ending shutdown, when the second temperature-proportional voltage VPTAT2 is lower than or equal to the second reference voltage Vref2, the second temperature detection signal STD1 may be provided for shutdown.

Step S100 of detecting the first temperature-proportional voltage VPTAT1 may include generating, by the first PTAT current generation unit 110, a first current proportional to the absolute temperature, and converting the first current into the first temperature-proportional voltage VPTAT1.

Here, in step S100 of detecting the first temperature-proportional voltage VPTAT1, first, the first PTAT current generation unit 110 may generate the first current proportional to the absolute temperature, and then, convert the first current into the first temperature-proportional voltage VPTAT1.

For example, step S300 of performing shutdown may include generating, by the second PTAT current generation unit 210 set to have the same temperature characteristics as those of the first PTAT current generation unit 110, the second current proportional to the absolute temperature and equal to the first current, and converting the second current into the second temperature-proportional voltage VPTAT2.

Here, in step S300 of performing the shutdown, first, the second PTAT current generation unit 210 set to have the same temperature characteristics as those of the first PTAT current generation unit 110 may generate the second current proportional to the absolute temperature and equal to the first current, and then, convert the second current into the second temperature-proportional voltage VPTAT2.

In step S400 of comparing the second temperature-proportional voltage VPTAT2 with the second reference voltage Vref2 to determine whether or not the second temperature-proportional voltage VPTAT2 is lower than or equal to the second reference voltage Vref2, the second temperature T2 is set to be lower than the first temperature T1, so the second reference voltage Vref2 and the first reference voltage Vref1 may be set to be mutually different.

In another example, step S300 of performing shutdown may include generating, by the second PTAT current generation unit 210 set to have temperature characteristics different from those of the first PTAT current generation unit 110, the second current proportional to the absolute temperature, and converting the second current into the second temperature-proportional voltage VPTAT2.

Here, in step S300 of performing the shutdown, first, the second PTAT current generation unit 210 set to have temperature characteristics different from those of the first PTAT current generation unit 110 may generate the second current proportional to the absolute temperature, and then, convert the second current into the second temperature-proportional voltage VPTAT2.

In step S400 of comparing the second temperature-proportional voltage VPTAT2 with the second reference voltage Vref2 to determine whether or not the second temperature-proportional voltage VPTAT2 is lower than or equal to the second reference voltage Vref2, the second reference voltage Vref2 and the first reference voltage Vref1 may be set to be equal.

In the embodiments of the present invention as described above, the automatic thermal shutdown of the motor driver IC is provided to shut down every output of the motor driver IC when the temperature of the IC is overly increased, to prevent an increase in the temperature to thus protect the IC.

When the temperature of the motor driver IC is sufficiently dropped to be lower than the shutdown temperature, the output of the motor driver IC is turned on so as to be automatically returned to the original operation.

In an embodiment of the present invention, the temperature sensor for the thermal shutdown function is implemented through a CMOS process using a MOSFET, instead of the existing BJT transistor, whereby the charge area can be reduced, the fabrication can be facilitated, and the unit production cost can be reduced.

As set forth above, according to embodiments of the invention, the automatic thermal shutdown circuit can be applied to a motor driver IC and can be implemented through a CMOS process. Thus, the charge area and the costs of production can be reduced, and since the automatic thermal shutdown circuit can automatically perform a shutdown function within a pre-set temperature range, it can operate effectively.

While the present invention has been shown and described in connection with the embodiments, it will be apparent to those skilled in the art that modifications and variations can be made without departing from the spirit and scope of the invention as defined by the appended claims.

What is claimed is:

1. An automatic thermal shutdown circuit comprising:
a first temperature detection unit detecting a temperature equal to or above a pre-set first temperature and providing a first temperature detection signal;
a second temperature detection unit detecting a temperature equal to or below a second temperature previously set to be lower than the first temperature and providing a second temperature detection signal; and
a shutdown signal generation unit providing a shut down signal according to the first temperature detection signal from the first temperature detection unit and cutting the shutdown signal according to the second temperature detection signal from the second temperature detection unit.

2. The automatic thermal shutdown circuit of claim 1, wherein the first and second temperature detection units and the shutdown signal generation unit are implemented through a CMOS process using a MOSFET.

3. The automatic thermal shutdown circuit of claim 2, wherein the first temperature detection unit comprises:
a first PTAT current generation unit generating a first current proportional to an absolute temperature;
a first current/voltage conversion unit converting the first current into a first temperature-proportional voltage; and
a first comparison unit providing the first temperature detection signal when the first temperature-proportional voltage is higher than a pre-set first reference voltage so as to correspond to the first temperature.

4. The automatic thermal shutdown circuit of claim 3, wherein the second temperature detection unit comprises:
a second PTAT current generation unit set to have the same temperature characteristics as those of the first PTAT current generation unit and generating a second current proportional to the absolute temperature and equal to the first current;
a second current/voltage conversion unit converting the second current into a second temperature-proportional voltage equal to the first temperature-proportional voltage; and
a second comparison unit providing a second temperature detection signal when the second temperature-proportional voltage is lower than or equal to a second reference voltage previously set to be lower than the first reference voltage so as to correspond to a second temperature lower than the first temperature.

5. The automatic thermal shutdown circuit of claim 4, wherein the shutdown signal generation unit comprises an RS latch, set to provide a shutdown signal when the first temperature detection signal has a high level, and reset to cut the shutdown signal when the second temperature detection signal has a high level.

6. The automatic thermal shutdown circuit of claim 2, wherein the first temperature detection unit comprises:
a first PTAT current generation unit generating a first current proportional to the absolute temperature;
a first current/voltage conversion unit converting the first current into a first temperature-proportional voltage; and
a first comparison unit providing the first temperature detection signal when the first temperature-proportional voltage is higher than a first reference voltage previously set to correspond to the first temperature.

7. The automatic thermal shutdown circuit of claim 6, wherein the second temperature detection unit comprises:
a second PTAT current generation unit set to have temperature characteristics different from those of the first PTAT current generation unit and generating a second current proportional to the absolute temperature;
a second current/voltage conversion unit converting the second current into a second temperature-proportional voltage; and
a second comparison unit providing a second temperature detection signal when the second temperature-proportional voltage is lower than or equal to the first reference voltage.

8. The automatic thermal shutdown circuit of claim 7, wherein the shutdown signal generation unit comprises an RS latch, set to provide the shutdown signal when the first temperature detection signal has a high level, and reset to cut the shutdown signal when the second temperature detection signal has a high level.

9. An automatic thermal shutdown method comprising:
detecting a first temperature-proportional voltage through a first PTAT current generation unit;
comparing the first temperature-proportional voltage with a first reference voltage previously set to correspond to a pre-set first temperature to determine whether or not the first temperature-proportional voltage is higher than the first reference voltage;
performing a shutdown, via a shutdown signal generation unit, when the first temperature-proportional voltage is higher than the first reference voltage, and detecting a second temperature-proportional voltage through a second PTAT current generation unit;
comparing the second temperature-proportional voltage with a second reference voltage previously set to correspond to a pre-set second temperature to determine whether the second temperature-proportional voltage is lower than or equal to the second reference voltage; and
ending the shutdown by the shutdown signal generation unit when the second temperature-proportional voltage is lower than or equal to the second reference voltage.

10. The method of claim 9, wherein the first temperature detection unit, the second temperature detection unit and the shutdown signal generation unit are implemented through a CMOS process using a MOSFET, respectively.

11. The method of claim 10, wherein, in the performing of the shutdown, when the first temperature-proportional voltage is higher than the first reference voltage, a first temperature detection signal is provided to perform the shutdown.

12. The method of claim 10, wherein, in the ending of the shutdown, when the second temperature-proportional voltage is lower than or equal to the second reference voltage, a second temperature detection signal is provided to perform the shutdown.

13. The method of claim 10, wherein, the detecting of the first temperature-proportional voltage comprises:
generating, by a first PTAT current generation unit, a first current proportional to the absolute temperature; and
converting the first current into a first temperature-proportional voltage.

14. The method of claim 13, wherein the performing of the shutdown comprises:
generating, by a second PTAT current generation unit set to have the same temperature characteristics as those of the first PTAT current generation unit, a second current proportional to the absolute temperature and equal to the first current; and
converting the second current into a second temperature-proportional voltage equal to the first temperature-proportional voltage.

15. The method of claim 14, wherein, in the comparing of the second temperature-proportional voltage with the second reference voltage to determine whether the second temperature-proportional voltage is lower than or equal to the second reference voltage, the second temperature is set to be lower than the first temperature, so the second reference voltage and the first reference voltage may be set to be different voltages.

16. The method of claim 13, wherein the performing of the shutdown comprises:
generating, by the second PTAT current generation unit set to have temperature characteristics different from those of the first PTAT current generation unit, a second current proportional to the absolute temperature; and
converting the second current into the second temperature-proportional voltage.

17. The method of claim 16, wherein, in the comparing of the second temperature-proportional voltage with the second reference voltage to determine whether the second temperature-proportional voltage is lower than or equal to the second reference voltage, the second reference voltage and the first reference voltage are set to be equal.
